(19) United States
(12) Patent Application Publication
(10) Pub. No.: US 2009/0320781 A1
(43) Pub. Date: Dec. 31, 2009

(54) LNG FUEL SUPPLY SYSTEM

(75) Inventor: Sunggu Kwon, Seoul (KR)

Correspondence Address: MORGAN, LEWIS & BOCKIUS LLP (SF), One Market, Spear Street Tower, Suite 2800, San Francisco, CA, 94105, US

(73) Assignee: Hyundai Motor Company, Seoul (KR)

(21) Appl. No.: 12/274,139

(22) Filed: Nov. 19, 2008

(30) Foreign Application Priority Data
Jun. 26, 2008 (KR) 10-2008-0061054

(51) Int. Cl. F17C 5/02; F02M 21/02

(52) U.S. Cl. 123/1 A; 141/37; 141/51

(57) ABSTRACT

An LNG supply system may include first and second LNG tanks, a connecting line connecting the first LNG tank with the second LNG tank and in which a time relay valve is disposed, a charging line one side of which is connected to a fuel supply portion and the other side of which is connected to the first LNG tank for charging fuel, a vent line, one side of which is connected to the second LNG tank and the other side of which is open, a direct line connecting the first LNG tank and the second LNG tank, and a supply line branched from one side of the connecting line to supply an engine with LNG, wherein the time relay valve is opened for a predetermined period so as to equalize the amount of LNG that is charged in the first LNG tank and the second LNG tank.

### CROSS-REFERENCE TO RELATED APPLICATION

The present application claims priority to Korean Patent Application No. 10-2008-0061054, filed on Jun. 26, 2008, the entire contents of which are incorporated herein for all purposes by this reference.

### BACKGROUND OF THE INVENTION

1. Field of the Invention

The present invention relates to an engine of a vehicle, and more particularly to a liquefied natural gas (LNG) fuel supply system for securely supplying an engine with LNG and efficiently charging two different fuel tanks with LNG.

2. Description of Related Art

When charging a storage tank, the temperature of the storage tank is lowered by vaporization of the LNG to store the LNG in a liquid state.

Particularly, the liquefaction temperature of liquid propane gas (LPG) is about minus 47° C., however, the liquefaction temperature of LNG is about minus 160° C. such that it is more difficult to charge and store the LNG than the LPG.

The time for the temperature to decrease is longer as the volume of the storage tank is increases when charging the storage tank with LNG fuel. Moreover, vaporized gas can be excessively generated inside the storage tank in this process. Accordingly, the charging efficiency can be decreased.

Further, there is a problem with conventional systems in that the fuel is not reliably supplied by a difference of vaporization pressure when at least two storage tanks are used in the case in which remaining fuel amounts are different. Particularly, it is not appropriate or effective when a large output is required.

The information disclosed in this Background of the Invention section is only for enhancement of understanding of the general background of the invention and should not be taken as an acknowledgement or any form of suggestion that this information forms the prior art already known to a person skilled in the art.

### BRIEF SUMMARY OF THE INVENTION

Various aspects of the present invention are directed to provide a fuel supply system, and in particular an LNG fuel supply system, having advantages of securely and reliably supplying different storage tanks of a vehicle with LNG fuel and efficiently charging the different storage tanks with LNG fuel.

An LNG supply system may include a second LNG tank that is spaced apart from a first LNG tank and a connecting line that connects the first LNG tank with the second LNG tank. A time relay valve may be disposed between the first LNG tank and second LNG tank. The system may further include a charging line, one side of which is connected to a fuel supply portion and the opposite side connected to a first portion of the connecting line between the first LNG tank and the time relay valve for charging LNG; a vent line, one side of which is connected to the second LNG tank and the opposite side of which is open; a direct line that connects the first LNG tank and the second LNG tank; and a supply line that is branched from a second portion of the connecting line between the first LNG tank and the time relay valve to supply an engine with the LNG. The time relay valve may be configured to open for a predetermined time period so as to equalize the amount of LNG that is charged in the first LNG tank and the second LNG tank. In various embodiments, the direct line connects the first LNG tank and the second LNG tank substantially directly.

A first control valve may be disposed between the first LNG tank and the time relay valve and the first and second portions of the connecting line may be displaced between the first control valve and the time relay valve. The first control valve may be a magnet valve. The first control valve may be opened to charge the first LNG tank.

A second control valve may be disposed between the time relay valve and the second LNG tank. The direct line may be connected to the connecting line between the time relay valve and the second control valve. The second control valve may be a magnet valve. The second control valve may be opened to charge the second LNG tank. A first valve assembly and a third control valve may be disposed at the direct line between the first LNG tank and the second control valve. The third control valve may be a magnet valve. The third control valve may be selectively opened to charge the second LNG tank. A first relief valve, a second relief valve, and a first pressure gauge may be disposed at the first valve assembly.

The other side of the vent line may be connected to the fuel supply portion.

A second valve assembly and a fourth control valve may be displaced at the vent line between the second LNG tank and the fuel supply system. A third relief valve, a fourth relief valve, and a second pressure gauge may be disposed at the second valve assembly.

A liquid sensor may be disposed at the other side of the vent line to detect liquid LNG.

The time relay valve may be opened when the LNG may be supplied to the engine such that the LNG of the first LNG tank and the second LNG tank may be supplied to the engine simultaneously. The LNG may be first charged to the first LNG tank through the charging line, and after charging the first LNG tank in the predetermined time period, the second LNG tank may be charged through the direct line. When the first LNG tank is charged, the time relay valve may be closed, but when the second LNG tank is charged, the time relay valve may be opened.

The information disclosed in this Background of the Invention section is only for enhancement of understanding of the general background of the invention and should not be taken as an acknowledgement or any form of suggestion that this information forms the prior art already known to a person skilled in the art.

The methods and apparatuses of the present invention have other features and advantages which will be apparent from or are set forth in more detail in the accompanying drawings, which are incorporated herein, and the following Detailed Description of the Invention, which together serve to explain certain principles of the present invention.

### BRIEF DESCRIPTION OF THE DRAWINGS

FIG. 1 is a schematic diagram showing a state in which LNG is being charged in an exemplary LNG fuel supply system according to various aspects of the present invention.

FIG. 2 is a schematic diagram showing a state in which LNG is uniformly sustained in first and second tanks in an exemplary LNG fuel supply system according to various aspects of the present invention.

FIG. 3 is a schematic diagram showing a state in which LNG is supplied to first and second tanks in an exemplary LNG fuel supply system according to various aspects of the present invention.

### DETAILED DESCRIPTION OF THE INVENTION

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

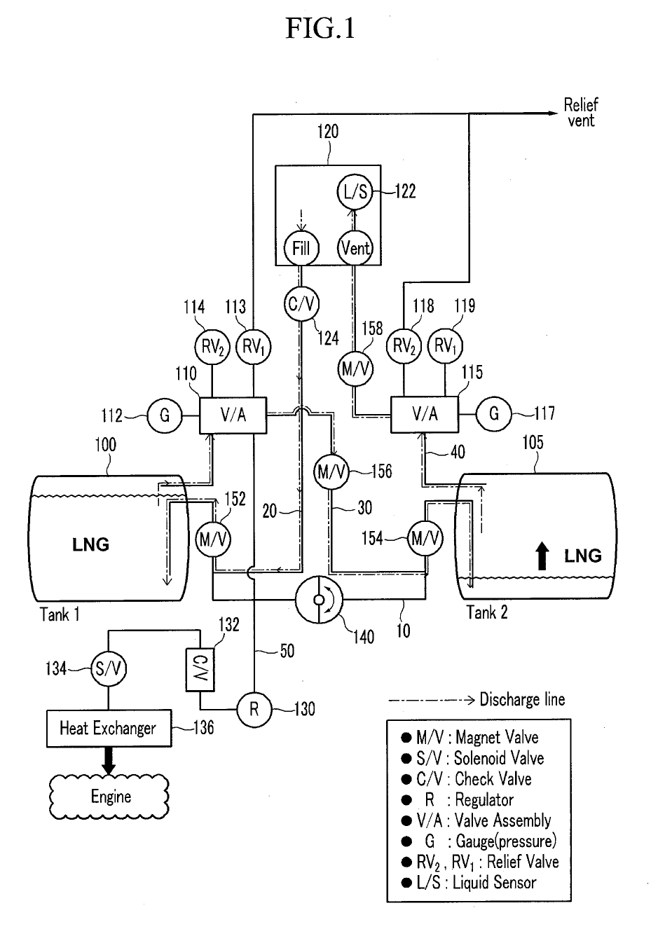

FIG. 1 is a schematic diagram showing a state in which LNG is being charged in a LNG fuel supply system according to the present invention.

Referring to FIG. 1, an LNG fuel supply system includes a first LNG tank 100, a second LNG tank 105, a connecting line 10, a charging line 20, a direct line 30, a vent line 40, and a supply line 50.

One end portion of the connecting line 10 is connected to the first LNG tank 100. The other opposite end portion is connected to a second LNG tank 105. A first magnet valve 152, a time relay valve 140, and a second magnet valve 154 are sequentially disposed at the connecting line 10.

One end portion of the charging line 20 is connected to the connecting line 10 between the first magnet valve 152 and the time relay valve 140. The other opposite end portion is connected to a fuel supply portion 120. A first check valve 124 may be mounted on the charging line 20 adjacent to the fuel supply portion 120.

One end portion of the direct line 30 is connected to the first LNG tank 100. The opposite end portion is connected to the connecting line 10 between the time relay valve 140 and the second magnet valve 154. Also, a first valve assembly 110 and a third magnet valve 156 are sequentially disposed at the direct line 30. Herein, a first pressure gauge 112, a first relief valve 113, and a second relief valve 114 are mounted on the first valve assembly 110.

One end portion of the vent line 40 is connected to the second LNG tank 105. The opposite end portion is connected to the fuel supply portion 120. Also, a second valve assembly 115 and a fourth magnet valve 158 are sequentially disposed at the vent line 40, and a liquid sensor 122 is mounted on the other end portion.

Herein, a second pressure gauge 117, a third relief valve 118, and a fourth relief valve 119 are mounted on the second valve assembly 115. Particularly, the first relief valve 113 and the third relief valve 118 are connected to a separate vent line.

One end portion of the supply line 50 is connected to the connecting line 10 between the first magnet valve 152 and the time relay valve 140. The other end portion is connected to the engine. A regulator 130, a second check valve 132, a solenoid valve 134, and a heat exchanger 136 are sequentially disposed at the supply line 50. As shown in FIG. 1, the supply line 50 can be connected to the first valve assembly 110.

Referring to FIG. 1, the first LNG tank 100 is charged with LNG fuel that is supplied from the fuel supply portion 120 through the first check valve 124 and the first magnet valve 152 via the charging line 20. Herein, the time relay valve 140 sustains its closed condition.

The first LNG tank 100 is first charged, and the second LNG tank 105 is next charged through the direct line 30. The second LNG tank 105 is fully charged with liquid LNG through the vent line 40, and the liquid LNG flows through the vent line 40 in which the liquid sensor 122 detects the liquid LNG. The LNG fuel charging is completed when the liquid sensor 122 detects the liquid LNG.

A control portion may be electrically connected to the constituent elements. The control portion controls the constituent elements according to a predetermined program. For example, during charging of the LNG fuel, the control portion opens the first magnet valve 152 and closes the time relay valve 140.

When the LNG amounts that are charged in the first LNG tank 100 and the second LNG tank 105 are significantly different from each other, the LNG fuel can not be securely supplied to the engine. In such a case, the method discussed above may be applied to resolve the problem.

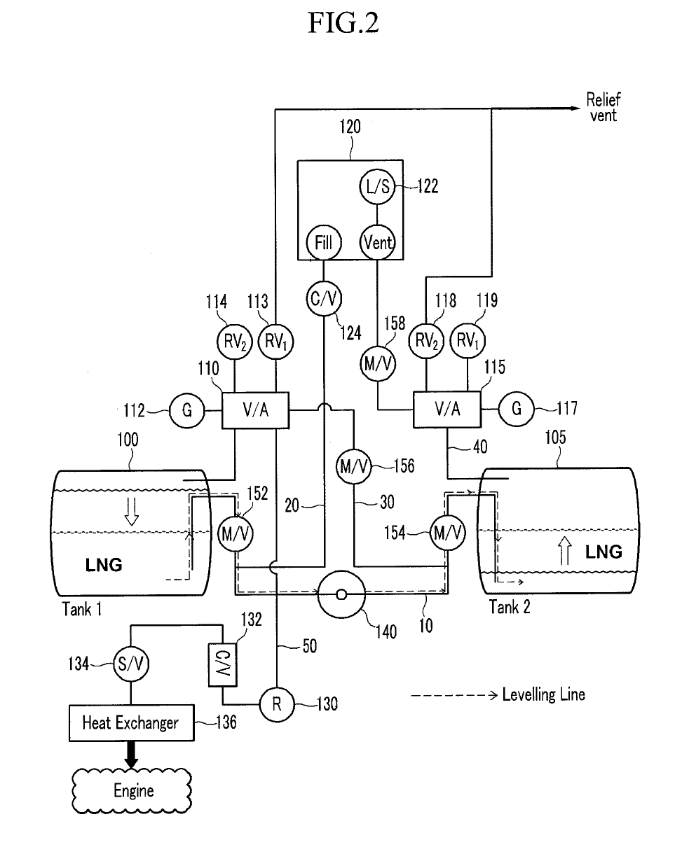

FIG. 2 is a schematic diagram showing a state in which LNG is uniformly sustained in first and second tanks 100 and 105 in an LNG fuel supply system according to the present invention.

Referring to FIG. 2, the first LNG tank 100 is almost fully charged with the LNG fuel, and on the contrary, the fuel of the second LNG tank 105 is almost exhausted. Herein, the time relay valve 140 and the first and second magnet valves 152 and 154 are opened by the control portion.

Accordingly, the LNG of the first LNG tank 100 flows to the second LNG tank 105 through the connecting line 10, and the fuel amounts of the first and second LNG tanks 100 and 105 are almost equally sustained. Herein, the time relay valve 140 can be closed in a predetermined time.

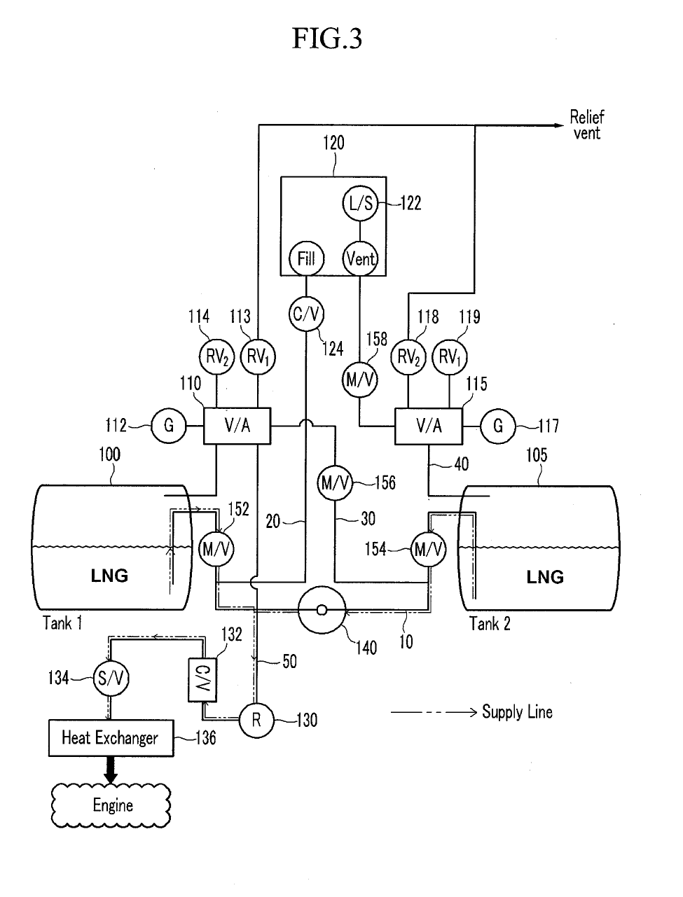

FIG. 3 is a schematic diagram showing a state in which LNG is supplied to first and second tanks in a LNG fuel supply system according to the present invention.

Referring to FIG. 3, in a case in which the LNG is supplied through the supply line 50, the first and second magnet valves 152 and 154 are opened and the time relay valve 140 is opened.

Accordingly, the fuel that is stored in the first and second LNG tanks 100 and 105 is supplied together to the supply line 50 such that the fuel is securely supplied in a reliable and effective manner. The fuel levels of the first and second LNG tanks 100 and 105 are equally formed by the time relay valve 140.

In brief, the time relay valve causes the levels of the different storage tanks to be equal and thereby the LNG can be securely supplied. Further, the different storage tanks are sequentially charged and thereby the LNG fuel is efficiently charged. One will further appreciate from the foregoing that other modifications and variations may be made in accordance with the present invention including, but not limited to, modification of the system for CNG and other fuel sources.

For convenience in explanation and accurate definition in the appended claims, the terms “upper” or “lower”, “front” or “rear”, “inside” or “outside”, and etc. are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A LNG supply system, comprising;
a second LNG tank that is spaced apart from a first LNG tank;
a connecting line that connects the first LNG tank with the second LNG tank, wherein a time relay valve is disposed between the first LNG tank and the second LNG tank;
a charging line, one side of which is connected to a fuel supply portion and the other side of which is connected to a first portion of the connecting line between the first LNG tank and the time relay valve for charging LNG;
a vent line, one side of which is connected to the second LNG tank and the other side of which is open;
a direct line that connects the first LNG tank and the second LNG tank; and
a supply line that is branched from a second portion of the connecting line between the first LNG tank and the time relay valve to supply an engine with the LNG,
wherein the time relay valve is configured to be opened for a predetermined time period so as to equalize the amount of LNG that is charged in the first LNG tank and the second LNG tank.

2. The LNG supply system of claim 1, wherein a first control valve is disposed between the first LNG tank and the time relay valve, and the first and second portions of the connecting line are displaced between the first control valve and the time relay valve.

3. The LNG supply system of claim 2, wherein the first control valve is a magnet valve.

4. The LNG supply system of claim 2, wherein the first control valve is configured to open to charge the first LNG tank.

5. The LNG supply system of claim 1, wherein a second control valve is disposed between the time relay valve and the second LNG tank, and the direct line is connected to the connecting line between the time relay valve and the second control valve.

6. The LNG supply system of claim 5, wherein the second control valve is a magnet valve.

7. The LNG supply system of claim 5, wherein the second control valve is opened to charge the second LNG tank.

8. The LNG supply system of claim 5, wherein a first valve assembly and a third control valve are disposed at the direct line between the first LNG tank and the second control valve.

9. The LNG supply system of claim 8, wherein the third control valve is a magnet valve.

10. The LNG supply system of claim 8, wherein the third control valve is configured to selectively open to charge the second LNG tank.

11. The LNG supply system of claim 8, wherein a first relief valve, a second relief valve, and a first pressure gauge are disposed at the first valve assembly.

12. The LNG supply system of claim 1, wherein the other side of the vent line is connected to the fuel supply portion.

13. The LNG supply system of claim 1, wherein a second valve assembly and a fourth control valve are displaced at the vent line between the second LNG tank and the fuel supply system.

14. The LNG supply system of claim 13, wherein a third relief valve, a fourth relief valve, and a second pressure gauge are disposed at the second valve assembly.

15. The LNG supply system of claim 1, wherein a liquid sensor is disposed at the other side of the vent line to detect liquid LNG.

16. The LNG supply system of claim 1, wherein the time relay valve is configured to open when the LNG is supplied to the engine so the LNG of the first LNG tank and the second LNG tank is supplied to the engine substantially simultaneously.

17. The LNG supply system of claim 16, wherein the LNG is first charged to the first LNG tank through the charging line, and after charging the first LNG tank in the predetermined time period, the second LNG tank is charged through the direct line.

18. The LNG supply system of claim 17, wherein when the first LNG tank is charged, the time relay valve is closed, but when the second LNG tank is charged, the time relay valve is opened.

19. An engine comprising the LNG supply system as defined in claim 1.

20. A passenger vehicle comprising the LNG supply system as defined in claim 1.
